(19) United States
(12) Patent Application Publication
(10) Pub. No.: US 2024/0093128 A1
(43) Pub. Date: Mar. 21, 2024

(54) FOAMABLE CLEANING AGENT FOR AIR INTAKE SYSTEM AND AEROSOL PRODUCT CONTAINING THE SAME

(71) Applicants: Henkel AG & Co. KGaA, Duesseldorf (DE); Guangdong Yingde Dosoon Fine Chemical Industry Co., Ltd., Qingyuan (CN)

(72) Inventors: GuoGuang Liu, Shanghai (CN); HongYu Chu, Shanghai (CN); Bo Xu, Shanghai (CN); Xiaohui Pan, Lianzhou (CN); Zengfan Liu, Guangzhou (CN)

(21) Appl. No.: 18/525,174

(22) Filed: Nov. 30, 2023

Related U.S. Application Data
(63) Continuation of application No. PCT/CN2021/097590, filed on Jun. 1, 2021.

(51) Int. Cl. C11D 17/00; C10M 101/00; C11D 1/12; C11D 1/66; C11D 1/83; C11D 1/86; C11D 3/00; C11D 3/06; C11D 3/18; C11D 3/20; C11D 3/37; C11D 3/43; C11D 11/00

(52) U.S. Cl. CPC C11D 17/0043; C10M 101/00; C11D 1/123; C11D 1/66; C11D 1/662; C11D 1/83; C11D 1/86; C11D 3/0005; C11D 3/0073; C11D 3/06; C11D 3/18; C11D 3/181; C11D 3/2068; C11D 3/2079; C11D 3/3703; C11D 3/43; C11D 11/0029; C10M 2203/003; C10N 2040/00

(57) ABSTRACT

The present invention provides a foamable cleaning agent for an air intake system, comprising: a) 6 to 10 wt. % of α-sulfo-fatty acid methyl ester salt and/or alpha-olefin sulfonate; b) 6 to 10 wt. % of alkyl polyglucoside APG2000; c) 1.5 to 2.5 wt. % of coconut oil fatty acid diethanolamide and/or lauric diethanol amide LDEA; and d) 5 to 15 wt. % of water; based on the total weight of the foamable cleaning agent, also provided are an aerosol product comprising: an aerosol can containing the foamable cleaning agent, and a spraying device, through which the foamable cleaning agent can be sprayed out as a foam; and a method for preparing the aerosol product, a method of cleaning air intake system with the aerosol product, and a use of the foamable cleaning agent or the aerosol product for cleaning air intake system.

### TECHNICAL FIELD

The present invention relates to a foamable cleaning agent for air intake systems. In particular, the foamable cleaning agent comprises: 6 to 10 wt. % of α-sulfo-fatty acid methyl ester salt and/or alpha-olefin sulfonate, 6 to 10 wt. % of alkyl polyglucoside APG2000, 1.5 to 2.5 wt. % of coconut oil fatty acid diethanolamide and/or lauric diethanol amide LDEA, and 5 to 15 wt. % of water, based on the total weight of the foamable cleaning agent.

### BACKGROUND OF THE INVENTION

Air intake systems are provided on vehicles to deliver sufficient, clean, dry and stable air to an internal combustion engine. During the operation of engine, carbon deposition, oil, fat and various other depositions are often generated on the air intake systems; and these depositions will lead to various faults of vehicles (including oil circuit plugging, increased oil consumption, improper air-fuel ratio, etc.), and air pollution, and they will negatively affect the lifetime of the engine. Thus, it is very necessary to regularly clean and maintain the air intake system of the engine.

However, current cleaning agents for the air intake system produce a lot of exhaust gases during cleaning; and the exhaust gases, which are inhaled into the bodies of people, produce a strong stimulus and are harmful to the bodies. Moreover, the current cleaning agents for the air intake system flow very quickly, cannot penetrate into the interior of the air intake system, and thus lead to insufficient time for emulsification and poor cleaning effect. In addition, the current cleaning agents for the air intake system may corrode tubes in the air intake system, negatively affect the safety of the tubes, and reduce the lifetime of the tubes.

Therefore, there is a need to develop a cleaning agent for the air intake system which can overcome at least one of the above disadvantages. In particular, the cleaning agent should have an excellent cleaning power and a good foaming performance, and should defoam at a proper time.

### SUMMARY OF THE INVENTION

In accordance with a first aspect of the invention, there is provided a foamable cleaning agent for the air intake system, comprising:
a) 6 to 10 wt. % of α-sulfo-fatty acid methyl ester salt and/or alpha-olefin sulfonate,
b) 6 to 10 wt. % of alkyl polyglucoside APG2000,
c) 1.5 to 2.5 wt. % of coconut oil fatty acid diethanolamide and/or lauric diethanol amide LDEA, and
d) 5 to 15 wt. % of water,
   based on the total weight of the foamable cleaning agent.

In accordance with a second aspect of the present invention, there is provided an aerosol product, comprising: an aerosol can containing the foamable cleaning agent of the present invention, and a spraying device, through which the foamable cleaning agent can be sprayed out as a foam.

In accordance with a third aspect of the present invention, there is provided a method for preparing the aerosol product of the present invention, comprising the following steps: mixing all the components of the foamable cleaning agent of the present invention except the propellant, stirring the mixture at 200 to 1000 rpm, filling it into the aerosol can, sealing the can, filling the propellant into the can, and fitting the can with the spraying device.

In accordance with a fourth aspect of the present invention, there is provided a method of cleaning automotive air intake systems with the aerosol product of the present invention or an aerosol product prepared by the method of the present invention, comprising the following steps: warming up the engine for at least 10-15 minutes, removing the hose at the front of the throttle valve to expose the throttle valve, shaking the aerosol product of the present invention or the aerosol product prepared by the method of the present invention, stepping on the throttle to keep the throttle valve open, injecting the foamable cleaning agent in the aerosol product into the air intake system through the throttle valve, standing still for 3-5 minutes, starting the engine, increasing the engine speed to 1500-3000 r/min until white smoke disappears, and resetting the hose at the front of the throttle valve.

In accordance with a fifth aspect of the present invention, there is provided a use of the foamable cleaning agent of the present invention or the aerosol product of the present invention for cleaning air intake systems.

As compared with the prior art, the foamable cleaning agent for the air intake system has an excellent cleaning power and a good foaming performance, and defoams at a proper time. Thus, it is very suitable as a cleaning agent for air intake systems. In particular, the foamable cleaning agent for the air intake system of the present invention produces a lot of fine foams; and these foams penetrate the interior of tubes in air intake systems, and effectively emulsify, dissolve and remove carbon deposition, oil, fat and other depositions.

### DETAILED DESCRIPTION OF THE INVENTION

It is to be understood by one of ordinary skill in the art that the present discussion is a description of exemplary embodiments only, and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, all wt. % values quoted herein are percentages by weight based on total weight of the foamable cleaning agent.

Unless specified otherwise, as used herein, the singular forms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

Unless specified otherwise, the recitation of numerical end points includes all numbers and fractions subsumed within the respective ranges, as well as the recited end points.

Unless otherwise defined, all terms used in the disclosing the invention, including technical and scientific terms, have the meaning as commonly understood by one of the ordinary skill in the art to which this invention belongs.

According to the present invention, surprisingly, a foamable cleaning agent for the air intake system comprising: specific combinations of 6 to 10 wt. % of α-sulfo-fatty acid methyl ester salt and/or alpha-olefin sulfonate; 6 to 10 wt. % of alkyl polyglucoside APG2000; 1.5 to 2.5 wt. % of coconut oil fatty acid diethanolamide and/or lauric diethanol amide LDEA; and 5 to 15 wt. % of water, based on the total weight of the foamable cleaning agent, has an excellent cleaning power and a good foaming performance, and defoams at a proper time.

α-Sulfo-Fatty Acid Methyl Ester Salt and/or Alpha-Olefin Sulfonate

In the present invention, α-sulfo-fatty acid methyl ester salt is preferably a compound of formula R₁CH(SO₃M)COOCH₃, in which R1 is preferably C12-C18 alkyl, and M is preferably a sodium ion, a potassium ion or an ammonium ion.

Preferably, R₁ is C14-C18 alkyl, preferably C16-C18 alkyl, more preferably C16 alkyl; and/or M is a sodium ion. Examples of commercially available α-sulfo-fatty acid methyl ester salt according to the present invention include, for example, sodium methyl tetradecanoate sulfonate C14MES, sodium methyl hexadecanoate sulfonate C16MES and sodium methyl stearate sulfonate C18MES, all of which are available from Taiko KLK.

Preferably, the alpha-olefin sulfonate in the present invention is sodium alpha-olefin sulfonate, which has a CAS no. 68439-57-6. Examples of commercially available alpha-olefin sulfonate according to the present invention include, for example, sodium alpha-olefin sulfonate AOS, which is available from Zanyu.

The content of the α-sulfo-fatty acid methyl ester salt and/or alpha-olefin sulfonate is 6 to 10 wt. %, based on the total weight of the foamable cleaning agent for the air intake system. Preferably, the content of the α-sulfo-fatty acid methyl ester salt and/or alpha-olefin sulfonate is 6.5 to 9.5 wt. %, preferably 7 to 9 wt. %, based on the total weight of the foamable cleaning agent. If said content is higher than 10 wt. % or lower than 6 wt. %, the cleaning power and foaming performance will be greatly decreased, and the defoaming time will be far from the desired defoaming time (2 minutes).

### Alkyl Polyglucoside APG2000

In the present invention, alkyl polyglucoside APG2000 is a product containing an alkyl polyglucoside (APG®) surfactant that is in a unique class of non-ionic surfactant obtained from renewable, plant-derived raw materials; and it is made from natural, renewable, plant-derived feedstocks, and is readily biodegradable.

Examples of commercially available alkyl polyglucoside APG2000 according to the present invention include, for example, Plantaren® 2000 N UP, which is available from BASF, Germany; APG 2000 DG, which is available from OQEMA; Blanova TENS APG 2000, which is available from Azelis Canada; and Plantacare® 2000 UP, which is available from BASF.

The content of the alkyl polyglucoside APG2000 is 6 to 10 wt. %, based on the total weight of the foamable cleaning agent for the air intake system. Preferably, the content of the alkyl polyglucoside APG2000 is 6.5 to 9.5 wt. %, preferably 7 to 9 wt. %, based on the total weight of the foamable cleaning agent. If said content is higher than 10 wt. % or lower than 6 wt. %, the cleaning power and foaming performance will be greatly decreased, and the defoaming time will be far from the desired defoaming time (2 minute).

Coconut Oil Fatty Acid Diethanolamide and/or Lauric Diethanol Amide LDEA

In the present invention, coconut oil fatty acid diethanolamide has CAS no. 68603-42-9.

Examples of commercially available coconut oil fatty acid diethanolamide according to the present invention include, for example, coconut oil fatty acid diethanolamide 6501, which is available from Jangsu Province Haian Petroleum Chemical Plant.

In the present invention, lauric diethanol amide LDEA has CAS no. 120-40-1. Examples of commercially available lauric diethanol amide LDEA according to the present invention include, for example, lauric diethanol amide LDEA, which is available from Jangsu Province Haian Petroleum Chemical Plant.

The content of the coconut oil fatty acid diethanolamide and/or lauric diethanol amide LDEA is 1.5 to 2.5 wt. %, based on the total weight of the foamable cleaning agent for the air intake system. Preferably, the content of the coconut oil fatty acid diethanolamide and/or lauric diethanol amide LDEA is 1.75 to 2.25 wt. %, preferably 1.9 to 2.1 wt. %, based on the total weight of the foamable cleaning agent for the air intake system. If said content is higher than 2.5 wt. % or lower than 1.5 wt. %, the cleaning power and foaming performance will be greatly decreased, and the defoaming time will be far from the desired defoaming time (2 minutes).

### Water

In the present invention, water can be deionized water, distilled water and/or tap water.

The content of water is 5 to 15 wt. %, based on the total weight of the foamable cleaning agent for the air intake system. Preferably, the content of water is 5 to 10 wt. %, preferably 5.5 to 9 wt. %, based on the total weight of the foamable cleaning agent for the air intake system. If said content is higher than 15 wt. % or lower than 5 wt. %, the cleaning power and foaming performance will be greatly decreased, and the defoaming time will be far from the desired defoaming time (2 minute).

### Optional Additives

In the present invention, the foamable cleaning agent for the air intake system of the present invention may further comprise one or more additives besides those described above. In particular, the foamable cleaning agent for the air intake system of the present invention may comprise an additive selected from the group consisting of a dispersant, an oxygen-rich solvent, an alkane solvent, an anti-corrosive agent for metals, a lubricant, and a propellant.

Preferably, the foamable cleaning agent according to the present invention further comprises a dispersant, an oxygen-rich solvent, an alkane solvent, an anti-corrosive agent for metals, a lubricant, and a propellant.

The dispersant which can be used in the practice of the present invention can be any dispersant conventionally used in the foamable cleaning agent; and it is preferably selected from the group consisting of polyethylene glycols and fatty acid polyoxyethylene methyl ethers (FMEE), is more preferably selected from the group consisting of PEG 200 and PEG 400, and is most preferably PEG 200.

In an embodiment of the present invention, the content of the dispersant is 1 to 5 wt. %, preferably 1.5 to 3 wt. %, based on the total weight of the foamable cleaning agent for the air intake system.

In the present invention, the oxygen-rich solvent refers to a solvent having OH—, which can be cracked into hydrogen ions and oxygen ions under high temperature conditions in the combustor to promote full combustion, increase combustion heat value, and improve carbon deposition cleaning performance. The oxygen-rich solvent can be selected from the group consisting of alcohols and alcohol ethers.

The oxygen-rich solvent is preferably selected from the group consisting of ethanol, isopropanol, ethylene glycol butyl ether and propylene glycol phenyl ether, and is more preferably selected from the group consisting of isopropanol, ethylene glycol butyl ether and propylene glycol phenyl ether. Most preferably, the oxygen-rich solvent is a mixture of isopropanol, ethylene glycol butyl ether and propylene glycol phenyl ether.

In an embodiment of the present invention, the content of the oxygen-rich solvent is 10 to 30 wt. %, preferably 15 to 28 wt. %, and more preferably 20 to 25 wt. %, based on the total weight of the foamable cleaning agent for the air intake system.

In a preferable embodiment of the present invention, the oxygen-rich solvent is a mixture of isopropanol, ethylene glycol butyl ether and propylene glycol phenyl ether, wherein based on the total weight of the foamable cleaning agent for the air intake system, the content of isopropanol is 8 to 20 wt. %, the content of ethylene glycol butyl ether is 1 to 7 wt. %, and the content of propylene glycol phenyl ether is 1 to 7 wt. %.

By adding the oxygen-rich solvent, the foamable cleaning agent of the air intake system of the present invention increases flammability of unburnt solid carried in the exhaust gases formed during combustion; and thus, the blackness and the amount of the exhaust gases are reduced, the amount of harmful gases is reduced, heat pollution is reduced, and energy is saved.

In the present invention, alkane solvent refers to a C6-C10 alkane, which can be conventionally used as a solvent in the art.

The alkane solvent is preferably selected from the group consisting of dearomatized solvents, alkane solvents having a flash point of 30 to 100, and isoparaffin solvents. Preferably, the alkane solvent is selected from the group consisting of D80 solvent and D100 solvent, and is more preferably D80 solvent.

Examples of commercially available alkane solvent according to the present invention include, for example, Exxsol D80, which is available from Mobil.

In an embodiment of the present invention, the content of the alkane solvent is 20 to 50 wt. %, preferably 25 to 40 wt. %, and more preferably 30 to 35 wt. %, based on the total weight of the foamable cleaning agent for the air intake system.

In the present invention, anti-corrosive agent for metals refers to a substance which can prevent or slow down corrosion of metals. Preferably, the anti-corrosive agent for metals is selected from the group consisting of sodium benzoate, sodium metasilicate pentahydrate and sodium dihydrogen phosphate, and is preferably selected from the group consisting of sodium benzoate and sodium dihydrogen phosphate. More preferably, the anti-corrosive agent for metals is a mixture of sodium benzoate and sodium dihydrogen phosphate.

In an embodiment of the present invention, the content of the anti-corrosive agent for metals is 0.1 to 1 wt. %, preferably 0.2 to 0.9 wt. %, and more preferably 0.3 to 0.8 wt. %, based on the total weight of the foamable cleaning agent for the air intake system.

In a preferable embodiment of the present invention, the anti-corrosive agent for metals is a mixture of sodium benzoate and sodium dihydrogen phosphate, wherein based on the total weight of the foamable cleaning agent for the air intake system, the content of sodium benzoate is 0.05 to 0.9 wt. %, and the content of sodium dihydrogen phosphate is 0.05 to 0.9 wt. %.

By adding the anti-corrosive agent, the foamable cleaning agent for the air intake system of the present invention does not corrode metal parts, plastic parts and rubber parts of the air intake system, can effectively prevent corrosion of the relevant parts of the air intake system, and has a reduced influence on the air intake system.

In the present invention, lubricant can be any lubricant conventionally used in the foamable cleaning agent for the air intake system. The lubricant can be selected from the group consisting of base oils. Examples of the lubricant include, but not limited to, mineral base oils, such as mineral oil; synthetic base oils, such as synthetic hydrocarbon, synthetic ester, polyether, silicone oil, hydrocarbon containing fluorine and phosphate; and plant base oils, such as ester oil.

Preferably, the lubricant is selected from the group consisting of mineral oil and silicone oil, and is preferably mineral oil.

In an embodiment of the present invention, the content of lubricant is 0.2 to 3 wt. %, preferably 0.5 to 2 wt. %, and more preferably 0.7 to 1.5 wt. %, based on the total weight of the foamable cleaning agent.

In the present invention, propellant can be any propellant conventionally used in the foamable cleaning agent for the air intake system. The propellant may comprise nitrogen, air, and mixtures thereof. The propellant may comprise a hydrofluoroolefin, a Trans-1,3,3,3-tetrafluoroprop-1-ene, and optionally a CAS number 1645-83-6 gas. One such propellant is commercially available from Honeywell International of Morristown, N.J. under the trade name HFO-1234ze or GWP-6. The propellant may comprise another hydrofluoroolefin, a trans-1-chloro-3,3,3-trifluoropropene, and optionally a CAS number 102687-65-0. One such propellant is commercially available from Honeywell International of Morristown, N.J. under the trade name Solstice® Performance Fluid (PF). The propellant may be comprised of a single chemical component or from a blend of one or more components to create the desired physical properties for the aerosol can. An example would be a physical blend of the HFO1234ze with the Solstice PF (HFO ZE/PF) in a 70:30 ratio by weight.

Preferably, the propellant may be selected from the group consisting of propane, butane and dimethyl ether. More preferably, the propellant is a mixture of propane and butane, and is preferably a mixture of propane and butane, wherein the volume ratio of propane to butane is 3:7.

In an embodiment of the present invention, the content of propellant is 5 to 25 wt. %, preferably 10 to 20 wt. %, and more preferably 12 to 18 wt. %, based on the total weight of the foamable cleaning agent.

In a preferable embodiment of the present invention, the foamable cleaning agent according to the present invention further comprises: 1 to 5 wt. % of a dispersant, 10 to 30 wt. % of an oxygen-rich solvent, 20 to 50 wt. % of an alkane solvent, 0.1 to 1 wt. % of an anti-corrosive agent for metals, 0.2 to 3 wt. % of a lubricant, and/or 5 to 25 wt. % of a propellant, based on the total weight of the foamable cleaning agent.

### Aerosol Product

Furthermore, the present invention provides an aerosol product, comprising: an aerosol can containing the foamable cleaning agent of the present invention, and a spraying device, through which the foamable cleaning agent can be sprayed out as a foam.

The aerosol can of the present invention can be any container which can be conventionally used for aerosol in the art.

The spraying device of the present invention can be any device which can be conventionally used for spraying aerosol from the aerosol can in the art.

The aerosol product according to the present invention can be made by any appropriate method. There are no particular restrictions on the production methods of the aerosol product of the present invention, as long as the method complies with a conventional method for producing the aerosol product. For example, the method for preparing the aerosol product comprises the following steps: mixing all the components of the foamable cleaning agent of the present invention except the propellant, stirring the mixture at 200 to 1000 rpm, filling it into the aerosol can, sealing the can, filling the propellant into the can, and fitting the can with the spraying device.

The aerosol product according to the present invention can be used for cleaning the automotive air intake system in any way which is conventional in the art. For example, a method of cleaning the automotive air intake system with the aerosol product according to the present invention or the aerosol product prepared by the method according to the present invention comprises the following steps: warming up the engine for at least 10-15 minutes, removing the hose at the front of the throttle valve to expose the throttle valve, shaking the aerosol product of the present invention or the aerosol product prepared by the method of the present invention, stepping on the throttle to keep the throttle valve open, injecting the foamable cleaning agent in the aerosol product into the air intake system through the throttle valve, standing still for 3-5 minutes, starting the engine, increasing the engine speed to 1500-3000 r/min until white smoke disappears, and resetting the hose at the front of the throttle valve.

In addition, the present invention provides a use of the foamable cleaning agent according to the present invention or the aerosol product according to the present invention for cleaning the air intake system, preferably in vehicles, especially in automobiles.

The aerosol product according to the present invention can produce a lot of fine foams in the interior of the air intake system, which can be effectively adhered on surface of oil and carbon depositions, has an excellent cleaning power and increases flammability of gases in the combustor. Moreover, this aerosol product has a small smell, can be used very easily and quickly, neither contains chlorohydrocarbons (such as dichloromethane and tetrachloroethylene) nor contains aromatic solvents (such as toluene and dimethylbenzene), and does not corrode metal parts, plastic parts and rubber parts in air intake systems.

Various features and embodiments of the disclosure are described in the following examples, which are intended to be representative and not limiting.

### EXAMPLES

Materials: The following materials were employed in the Examples:

| Material | Manufacturer | CAS No. |
|---|---|---|
| Sodium methyl hexadecanoate | Taiko KLK | 93348-22-2 |
| sulfonate C16MES | | |
| Sodium methyl dodecanoate | Taiko KLK | |
| sulfonate C12MES | | |
| Sodium methyl tetradecanoate | Taiko KLK | |
| sulfonate C14MES | | |
| Sodium methyl stearate | Taiko KLK | |
| sulfonate C18MES | | |
| Sodium dodecyl benzene | Nanjing Jiaji | |
| sulfonate LAS (Beizhuang) | New Material | |
| Sodium fatty acid | Jangsu Province | |
| polyoxyethylene ether | Haian Petroleum | |
| sulphate AES | Chemical Plant | |
| Sodium alpha-olefin sulfonate | ZANYU | |
| AOS | | |
| Alkyl polyglucoside APG2000 | BASF, Germany | |
| (Plantaren ® 2000 N UP) | | |
| Alkyl polyglucoside APG818 | BASF, Germany | |
| (APG 818 CG) | | |
| Alkyl polyglucoside APG1200 | BASF, Germany | |
| (Plantaren ® 1200 N UP) | | |
| Coconut oil fatty acid | Jangsu Province | 68603-42-9 |
| diethanolamide | Haian Petroleum | |
| | Chemical Plant | |

Materials: The following materials were employed in the Examples:

| Oleic acid diethanol amide | Jangsu Province | |
|---|---|---|
| ODEA | Haian Petroleum | |
| | Chemical Plant | |
| Stearyl diethanol amide SDEA | Jangsu Province | |
| | Haian Petroleum | |
| | Chemical Plant | |
| Lauric diethanol amide LDEA | Jangsu Province | |
| | Haian Petroleum | |
| | Chemical Plant | |
| N-dodecyl-N-methylglucamide | Guanzhou Chen Yu | |
| | Chemicals, Co., Ltd. | |
| PEG200 | DOW | 25322-68-3 |
| Isopropanol | DOW | 67-63-0 |
| Ethylene glycol butyl ether | DOW | 111-76-2 |
| Propylene glycol phenyl ether | DOW | 770-35-4 |
| D80 solvent | Mobil | 64742-47-8 |
| Sodium benzoate | Tenglong Chemical | 532-32-1 |
| | Co., Ltd. | |
| Sodium dihydrogen phosphate | KINDIA MAY | 7558-80-7 |
| Mineral oil | Mobil | 8042-47-5 |
| Mixture of propane and butane | China National | Propane: |
| (volume ratio of 3:7) | Offshore Oil | 74-98-6; |
| | Corporation | Butane: |
| | | 106-97-8. |

### Examples 1-21

To form the aerosol products containing the foamable cleaning agent as described in Tables 1-4, water, D80 solvent, isopropanol, ethylene glycol butyl ether, and propylene glycol phenyl ether were charged into a reactor according to the weight parts as shown in the tables. Under stirring at 800 rpm, sodium methyl hexadecanoate sulfonate C16MES, Sodium methyl dodecanoate sulfonate C12MES, Sodium methyl tetradecanoate sulfonate C14MES, Sodium methyl stearate sulfonate C18MES, Sodium dodecyl benzene sulfonate LAS, Sodium fatty acid polyoxyethylene ether sulphate AES, or Sodium alpha-olefin sulfonate AOS; alkyl polyglucoside APG2000, alkyl polyglucoside APG818 or alkyl polyglucoside APG1200; coconut oil fatty acid diethanolamide, N-dodecyl-N-methylglucamide, oleic acid diethanol amide ODEA, stearyl diethanol amide SDEA or Lauric diethanol amide LDEA; PEG 200; and mineral oil were charged into the reactor according to the weight parts as shown in the tables, and the resultant mixture was dispersed for 10 minutes. Under stirring at 1000 rpm, sodium benzoate and sodium dihydrogen phosphate were charged into the reactor according to the weight parts as shown in the tables, and the resultant mixture was dispersed for 15 minutes, thereby obtaining a base material. The base material was filtered through a 300-mesh filter, 300 g of the filtered base material was charged into a 550 ml aerosol can, and the aerosol can and a valve thereof were sealed with a sealing machine. Then, the aerosol can was filled with a mixture of propane and butane (volume ratio of 3:7) by an inflator, and was fitted with a spraying device, thereby obtaining a finish aerosol product.

The aerosol products as described in Tables 1-4 were then evaluated in accordance with the following methods.

Cleaning Power:
1. Preparation of oil stains: according to QB/T 2117-1995 general water-based metal detergent, oil stains (barium petroleum sulfonate 8%+lanolin magnesium soap 3.5%+lanolin 2%+industrial Vaseline™ 30%+No. 20 machine oil 34.5%+No. 30 machine oil 12%+calcium soap grease 2%+alumina 8%) were prepared, dissolved by heating to 120° C., stirred to be homogeneous, and cooled to room temperature.
2. Preparation of test piece with oil stains: steel plate having a size of 20 mm*40 mm was cleaned with absolute ethanol and then weighed (its weight was recorded as M0), and 1 g of the oil stains were evenly coated on one surface of the steel plate and then weighed (its weight was recorded as M1).
3. Cleaning: the test piece was fixed with a clamp and placed at 60° C., and then was horizontally swept with the aerosol product, wherein the outlet of the spraying pipe was at 15 cm from the test piece and the surface with oil stains of the test piece was covered with the cleaning agent. After the stains flowed down, the test piece was dried naturally, and weighed (its weight was recorded as M2).
4. Calculation of cleaning power: cleaning power was expressed as the weight percentage of the oil stains removed, and calculated according to the following equation:

X1=(M1−M2)*100/(M1−M0)

wherein X1 represents cleaning power in %, M0 represents the weight of the test piece in g, M1 represents the weight of the test piece coated with oil stains before cleaning in g, and M2 represents the weight of the test piece coated with oil stains after cleaning in g.

Foaming performance: a 100 ml glass beaker was placed on an electronic scale to weigh (its weight was recorded as M0), the aerosol product was shaken for 2 minutes to be homogeneous, and 10 g (M) of the foamable cleaning agent was sprayed into a 100 ml measuring cylinder. When the height of the foams generated reaches 100 ml, the foaming performance is 100%; and when the height of the foam generated reaches 60 ml, the foaming performance is 60%.

Defoaming time: the aerosol product was shaken for 2 minutes to be homogeneous, and sprayed into a 100 ml measuring cylinder until the foams generated reaches 100 ml. Then, record the time when the foams completely disappear.

When the defoaming time is close to 2 minutes, the foamable cleaning agent is suitable for air intake systems.

TABLE 1

| Components | Ex. 1 | Ex. 2 | Ex. 3 | Ex. 4 | Ex. 5 | Ex. 6 | Ex. 7 | Ex. 8 | Ex. 9 | Ex. 10 | Ex. 17 | Ex. 18 |
|---|---|---|---|---|---|---|---|---|---|---|---|---|
| Sodium methyl hexadecanoate | 8 | 4 | 11 | 8 | 8 | 8 | 8 | 8 | 8 | 8 | 8 | 8 |
| sulfonate C16MES | | | | | | | | | | | | |
| Alkyl polyglucoside APG2000 | 8 | 8 | 8 | | | 8 | 8 | 8 | 8 | 8 | 5 | 12 |
| Alkyl polyglucoside APG818 | | | | 8 | | | | | | | | |
| Alkyl polyglucoside APG1200 | | | | | 8 | | | | | | | |
| Coconut oil fatty acid | 2 | 2 | 2 | 2 | 2 | | 1 | 3 | | 2 | 2 | 2 |
| diethanolamide | | | | | | | | | | | | |
| N-dodecyl-N-methylglucamide | | | | | | 2 | | | | | | |
| PEG200 | 2 | 2 | 2 | 2 | 2 | 2 | 2 | 2 | 2 | | 2 | 2 |
| Water | 6 | 6 | 6 | 6 | 6 | 6 | 40.5 | 38.5 | | 65.50 | | |
| Isopropanol | 14 | 14 | 14 | 14 | 14 | 14 | 14 | 14 | 14 | | 14 | 14 |
| Ethylene glycol butyl ether | 5 | 5 | 5 | 5 | 5 | 5 | 5 | 5 | 5 | | 5 | 5 |
| Propylene glycol phenyl ether | 5 | 5 | 5 | 5 | 5 | 5 | 5 | 5 | 5 | | 5 | 5 |
| D80 solvent | 33.5 | 37.5 | 30.5 | 33.5 | 33.5 | 33.5 | | | 41.5 | | 42.5 | 35.5 |
| Sodium benzoate | 0.25 | 0.25 | 0.25 | 0.25 | 0.25 | 0.25 | 0.25 | 0.25 | 0.25 | 0.25 | 0.25 | 0.25 |
| Sodium dihydrogen phosphate | 0.25 | 0.25 | 0.25 | 0.25 | 0.25 | 0.25 | 0.25 | 0.25 | 0.25 | 0.25 | 0.25 | 0.25 |
| Mineral oil | 1 | 1 | 1 | 1 | 1 | 1 | 1 | 1 | 1 | 1 | 1 | 1 |
| Mixture of propane and butane | 15 | 15 | 15 | 15 | 15 | 15 | 15 | 15 | 15 | 15 | 15 | 15 |
| (3:7) | | | | | | | | | | | | |
| Tests | | | | | | | | | | | | |
| Cleaning power (%) | 99 | 85 | 90 | 80 | 85 | 90 | 25 | 30 | 80 | 50 | 75 | 85 |
| Foaming performance (%) | 98 | 89 | 88 | 80 | 85 | 82 | 30 | 36 | 65 | 85 | 80 | 90 |
| Defoaming time (min) | 2 | 1 | 5 | 1 | 1.5 | 1.5 | 1 | 4 | 1.5 | 5 | 4 | 4 |

As shown by Example 1 in the Table 1, by using the specific combination of 86 to 10 wt. % of α-sulfo-fatty acid methyl ester salt; 6 to 10 wt. % of alkyl polyglucoside APG2000; 1.5 to 2.5 wt. % of coconut oil fatty acid diethanolamide; and 5 to 15 wt. % of water, based on the total weight of the cleaning agent, the foamable cleaning agent for the air intake system according to the present invention both had an excellent cleaning power and a good foaming performance, and defoamed at a proper time. As illustrated by Examples 2-10 and 17-18, if any of the α-sulfo-fatty acid methyl ester salt and/or alpha-olefin sulfonate, the alkyl polyglucoside APG2000, the coconut oil fatty acid diethanolamide and/or lauric diethanol amide LDEA, and water, and the amounts thereof is not according to the present invention, the foamable cleaning agent for air intake system neither has an excellent cleaning power and a good foaming performance, nor has a defoaming time near 2 minutes; and a high amount of water leads to greatly reduced effects of the foamable cleaning agent in terms of cleaning power, foaming performance and defoaming time (see Examples 7, 8 and 10).

TABLE 2

| Components | Ex. 1 | Ex. 11 | Ex. 12 | Ex. 13 |
|---|---|---|---|---|
| Sodium methyl hexadecanoate | 8 | 8 | 8 | 8 |
| sulfonate C16MES | | | | |
| Alkyl polyglucoside APG2000 | 8 | 8 | 8 | 8 |
| Coconut oil fatty acid | 2 | | | |
| diethanolamide | | | | |
| Oleic acid diethanol amide ODEA | | 2 | | |
| Stearyl diethanol amide SDEA | | | 2 | |
| Lauric diethanol amide LDEA | | | | 2 |
| PEG200 | 2 | 2 | 2 | 2 |
| Water | 6 | 6 | 6 | 6 |
| Isopropanol | 14 | 14 | 14 | 14 |
| Ethylene glycol butyl ether | 5 | 5 | 5 | 5 |
| Propylene glycol phenyl ether | 5 | 5 | 5 | 5 |
| D80 solvent | 33.5 | 33.5 | 33.5 | 33.5 |
| Sodium benzoate | 0.25 | 0.25 | 0.25 | 0.25 |
| Sodium dihydrogen phosphate | 0.25 | 0.25 | 0.25 | 0.25 |
| Mineral oil | 1 | 1 | 1 | 1 |
| Mixture of propane and butane | 15 | 15 | 15 | 15 |
| (3:7) | | | | |
| Tests | | | | |
| Cleaning power (%) | 99 | 80 | 88 | 90 |
| Foaming performance (%) | 98 | 77 | 80 | 93 |
| Defoaming time (min) | 2 | 1 | 1 | 1 |

As illustrated in the table 2, as compared with other diethanolamides (such as oleic acid diethanol amide ODEA, and stearyl diethanol amide SDEA), by using coconut oil fatty acid diethanolamide and/or lauric diethanol amide LDEA, the foamable cleaning agent for air intake system according to the present invention both had an excellent cleaning power and a good foaming performance, and defoamed at a proper time.

TABLE 3

| Components | Ex. 1 | Ex. 14 | Ex. 15 | Ex. 16 |
|---|---|---|---|---|
| Sodium methyl hexadecanoate sulfonate C16MES | 8 | | | |
| Sodium dodecyl benzene sulfonate LAS | | 8 | | |
| Sodium fatty acid polyoxyethylene ether sulphate AES | | | 8 | |
| Sodium alpha-olefin sulfonate AOS | | | | 8 |
| Alkyl polyglucoside APG2000 | 8 | 8 | 8 | 8 |
| Coconut oil fatty acid diethanolamide | 2 | 2 | 2 | 2 |
| PEG200 | 2 | 2 | 2 | 2 |
| Water | 6 | 6 | 6 | 6 |
| Isopropanol | 14 | 14 | 14 | 14 |
| Ethylene glycol butyl ether | 5 | 5 | 5 | 5 |
| Propylene glycol phenyl ether | 5 | 5 | 5 | 5 |
| D80 solvent | 33.5 | 33.5 | 33.5 | 33.5 |
| Sodium benzoate | 0.25 | 0.25 | 0.25 | 0.25 |
| Sodium dihydrogen phosphate | 0.25 | 0.25 | 0.25 | 0.25 |
| Mineral oil | 1 | 1 | 1 | 1 |
| Mixture of propane and butane (3:7) | 15 | 15 | 15 | 15 |
| Tests | | | | |
| Cleaning power (%) | 99 | 92 | 94 | 95 |
| Foaming performance (%) | 98 | 93 | 92 | 95 |
| Defoaming time (min) | 2 | 4 | 4 | 1 |

As illustrated in the table 3, as compared with other surfactants (such as Sodium dodecyl benzene sulfonate LAS, and Sodium alcohol ether sulphate AES), by using the α-sulfo-fatty acid methyl ester salt and/or alpha-olefin sulfonate, the foamable cleaning agent for air intake system according to the present invention both had an excellent cleaning power and a good foaming performance, and defoamed at a proper time.

TABLE 4

| Components | Ex. 1 | Ex. 19 | Ex. 20 | Ex. 21 |
|---|---|---|---|---|
| Sodium methyl hexadecanoate sulfonate C16MES | 8 | | | |
| Sodium methyl dodecanoate sulfonate C12MES | | 8 | | |
| Sodium methyl tetradecanoate sulfonate C14MES | | | 8 | |
| Sodium methyl stearate sulfonate C18MES | | | | 8 |
| Alkyl polyglucoside APG2000 | 8 | 8 | 8 | 8 |
| Coconut oil fatty acid diethanolamide | 2 | 2 | 2 | 2 |
| PEG200 | 2 | 2 | 2 | 2 |
| Water | 6 | 6 | 6 | 6 |
| Isopropanol | 14 | 14 | 14 | 14 |
| Ethylene glycol butyl ether | 5 | 5 | 5 | 5 |
| Propylene glycol phenyl ether | 5 | 5 | 5 | 5 |
| D80 solvent | 33.5 | 33.5 | 33.5 | 33.5 |
| Sodium benzoate | 0.25 | 0.25 | 0.25 | 0.25 |
| Sodium dihydrogen phosphate | 0.25 | 0.25 | 0.25 | 0.25 |
| Mineral oil | 1 | 1 | 1 | 1 |
| Mixture of propane and butane (3:7) | 15 | 15 | 15 | 15 |
| Tests | | | | |
| Cleaning power (%) | 99 | 92 | 95 | 98 |
| Foaming performance (%) | 98 | 95 | 96 | 97 |
| Defoaming time (min) | 2 | 3 | 2 | 2 |

As illustrated in the table 4, by using an α-sulfo-fatty acid methyl ester salt, the foamable cleaning agent for air intake system according to the present invention both had an excellent cleaning power and a good foaming performance, and defoamed at a proper time.

What is claimed is:

1. A foamable cleaning agent for an air intake system, comprising components:
a) 6 to 10 wt. % of α-sulfo-fatty acid methyl ester salt and/or alpha-olefin sulfonate,
b) 6 to 10 wt. % of alkyl polyglucoside APG2000,
c) 1.5 to 2.5 wt. % of coconut oil fatty acid diethanolamide and/or lauric diethanol amide LDEA, and
d) 5 to 15 wt. % of water,
based on total weight of the foamable cleaning agent.

2. The foamable cleaning agent according to claim 1, wherein component a) is α-sulfo-fatty acid methyl ester salt with a formula of R₁CH(SO₃M)COOCH₃, in which R₁ is a C12-C18 alkyl and/or M is a sodium ion.

3. The foamable cleaning agent according to claim 1, wherein content of component a) is 6.5 to 9.5 wt. % based on the total weight of the foamable cleaning agent.

4. The foamable cleaning agent according to claim 1, wherein content of component b) is 6.5 to 9.5 wt. % based on the total weight of the foamable cleaning agent.

5. The foamable cleaning agent according to claim 1, wherein component c) comprises coconut oil fatty acid diethanolamide.

6. The foamable cleaning agent according to claim 1, wherein content of component c) is 1.75 to 2.25 wt. % based on the total weight of the foamable cleaning agent.

7. The foamable cleaning agent according to claim 1, wherein content of component d) is 5 to 10 wt. % based on the total weight of the foamable cleaning agent.

8. The foamable cleaning agent according to claim 1, further comprising an additive selected from a group consisting of a dispersant, an oxygen-rich solvent, an alkane solvent, an anti-corrosive agent for metals, a lubricant, and a propellant and combinations thereof.

9. The foamable cleaning agent according to claim 8, wherein the dispersant is selected from the group consisting of polyethylene glycols and fatty acid polyoxyethylene methyl ethers; the oxygen-rich solvent is selected from the group consisting of ethanol, isopropanol, ethylene glycol butyl ether and propylene glycol phenyl ether; the alkane solvent is selected from the group consisting of D80 solvent and D100 solvent; the anti-corrosive agent for metals is selected from the group consisting of sodium benzoate, sodium metasilicate pentahydrate and sodium dihydrogen phosphate; the lubricant is selected from the group consisting of mineral oil and silicone oil; and/or the propellant is a mixture of propane and butane.

10. The foamable cleaning agent according to claim 1, further comprising one or more of: 1 to 5 wt. % of a dispersant, 10 to 30 wt. % of an oxygen-rich solvent, 20 to 50 wt. % of an alkane solvent, 0.1 to 1 wt. % of an anti-corrosive agent for metals, 0.2 to 3 wt. % of a lubricant or 5 to 25 wt. % of a propellant, based on the total weight of the foamable cleaning agent.

11. The foamable cleaning agent according to claim 1, wherein the content ratio of component a) to component b) is 1:1.

12. The foamable cleaning agent according to claim 1, wherein the content of component a) is 7 to 9 wt. % based on the total weight of the foamable cleaning agent.

13. The foamable cleaning agent according to claim 12, wherein component a) is α-sulfo-fatty acid methyl ester salt with a formula of R₁CH(SO₃M)COOCH₃, in which R₁ is a C16-C18 alkyl.

14. The foamable cleaning agent according to claim 1, wherein the content of component b) is 7 to 9 wt. % based on the total weight of the foamable cleaning agent.

15. The foamable cleaning agent according to claim 1, wherein the content of component c) is 1.9 to 2.1 wt. % based on the total weight of the foamable cleaning agent.

16. A foamable cleaning agent for an air intake system, comprising components:
a) 6 to 10 wt. % of alpha-olefin sulfonate and/or α-sulfo-fatty acid methyl ester salt with a formula of R₁CH(SO₃M)COOCH₃ in which R₁ is a C12-C18 alkyl and M is either a sodium ion, a potassium ion, or an ammonium ion;
b) 6 to 10 wt. % of alkyl polyglucoside APG2000;
c) 1.5 to 2.5 wt. % of coconut oil fatty acid diethanolamide and/or lauric diethanol amide LDEA;
d) 5 to 15 wt. % of water, based on total weight of the foamable cleaning agent; and
e) an additive comprising an alkane solvent.

17. The foamable cleaning agent according to claim 16, wherein e) the additive further comprises one or more of a dispersant, an oxygen-rich solvent, an anti-corrosive agent for metals, a lubricant, and a propellant.

18. The foamable cleaning agent according to claim 17, wherein e) the additive comprises one or more of: 1 to 5 wt. % of the dispersant, 10 to 30 wt. % of the oxygen-rich solvent, 20 to 50 wt. % of the alkane solvent, 0.1 to 1 wt. % of the anti-corrosive agent for metals, 0.2 to 3 wt. % of the lubricant, 5 to 25 wt. % of the propellant, based on the total weight of the foamable cleaning agent.

19. An aerosol product for a foamable cleaning agent comprising:
an aerosol can containing a foamable cleaning agent comprising components:
a) 6 to 10 wt. % of α-sulfo-fatty acid methyl ester salt and/or alpha-olefin sulfonate,
b) 6 to 10 wt. % of alkyl polyglucoside APG2000,
c) 1.5 to 2.5 wt. % of coconut oil fatty acid diethanolamide and/or lauric diethanol amide LDEA, and
d) 5 to 15 wt. % of water,
based on total weight of the foamable cleaning agent; and further comprising propellant;
wherein the aerosol can has a spraying device, through which the foamable cleaning agent is sprayable as a foam.

20. A method for preparing the aerosol product according to claim 19, comprising steps of: mixing all the components of the foamable cleaning agent except the propellant; stirring the mixture at 200 to 1000 rpm; dispensing the mixture into the aerosol can; sealing the aerosol can; dispensing the propellant into the aerosol can; and fitting the aerosol can with the spraying device.

21. A method of cleaning the air intake system with the aerosol product according to claim 19 comprising the following steps: warming up an engine for at least 10-15 minutes, removing a hose from a throttle valve of a throttle to expose the throttle valve, shaking said aerosol product, opening the throttle valve open, injecting the foamable cleaning agent in the aerosol product into the air intake system through the throttle valve, waiting for 3-5 minutes, starting the engine, increasing engine speed to 1500-3000 revolutions/min until white smoke disappears, and resetting the hose onto the throttle valve.
